(19) United States
(12) Patent Application Publication
(10) Pub. No.: US 2004/0183358 A1
(43) Pub. Date: Sep. 23, 2004

(54) Structure between wheel and belt gear

(76) Inventor: Mao-Hung Chuang, Taipei (TW)

Correspondence Address: BROWDY AND NEIMARK, P.L.L.C., 624 NINTH STREET, NW, SUITE 300, WASHINGTON, DC, 20001-5303, US

(21) Appl. No.: 10/389,747

(22) Filed: Mar. 18, 2003

(51) Int. Cl. B60B 19/00

(52) U.S. Cl. 301/6.5

(57) ABSTRACT

An improved structure between wheel and belt gear is the exterior screw bulging out the outer edge of the central axle sleeve of a wheel hub for coupling and fastening the central axle sleeve of the self-acting clutch structure of gear. A connection structure installed between the central hole of gear and base ring of the self-acting clutch structure to form the belt gear, when the belt gear is driven by power, the self-acting clutch structure can hold screw tube for promoting the axle sleeve to rotate, when wheel is driven by pushing, the self-acting clutch structure can automatically release screw tube, and will not anti-drive the belt gear.

### BACKGROUND OF THE INVENTION

1. Field of the Invention

The present invention relates to a kind of an improved structure between wheel and belt gear. Particularly, it points to an improved structure between wheel and belt gear of electric scooters or bicycles . . . etc. in order to make this kind of small cars not only be used by power but also by pushing.

2. Prior Art

Look into a united structure between wheel and belt gear or a sprocket of electric scooters or bicycles . . . etc. A wheel hub and belt gear or a sprocket merge into an organic whole or interior screw is set in the axle hole of the center of sprocket or belt gear for coupling exterior screw of the axle sleeve of a wheel hub. Take the announcement in Taiwan Patent Communique No.465470; No.481162 and No.501573 for example, this kind of small cars only can be driven by power. If power in a storage battery has been used up on the way, the car without power is driven by pushing. Because the belt gear or sprocket cannot depart from a wheel hub, the proceeding wheels must anti-drive the belt gear or sprocket to move with the electric structure that not only require more power, but also elements are easily worn down or have a breakdown.

### OBJECTS OF THE INVENTION

The primary purpose of the present invention is to improve the loss mentioned above and provide an improved structure between wheel and belt gear in order to make wheels of the small cars without power progress by pushing; the belt gear or sprocket can automatically release wheels, and will not anti-drive electric device rotating.

### BRIEF DESCRIPTION OF DRAWING

FIG. 1 is a graphic view of the belt gear connecting with the axle sleeve of a wheel hub.

FIG. 2 is an indicating view of the decomposed structure of FIG. 1.

FIG. 3 is a square view of the structure of FIG. 1 in part.

FIG. 4 is an indicating view of FIG. 3 when the belt gear is driven by power.

FIG. 5 is an indicating view of FIG. 3 when a wheel hub is moved by pushing.

FIG. 6 is another graphic view of belt gear connecting with the axle sleeve of a wheel hub in another embodiment of the present invention.

FIG. 7 is an indicating view of the decomposed structure of FIG. 6.

### DETAILED DESCRIPTION OF THE INVENTION

Other objects, structure, and functions of the present invention will be described by way of example with reference to the accompanying drawings in which:

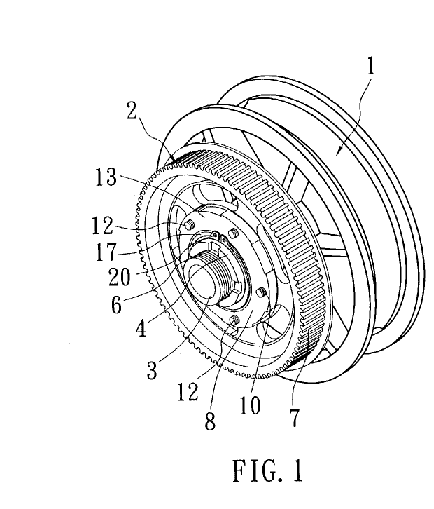

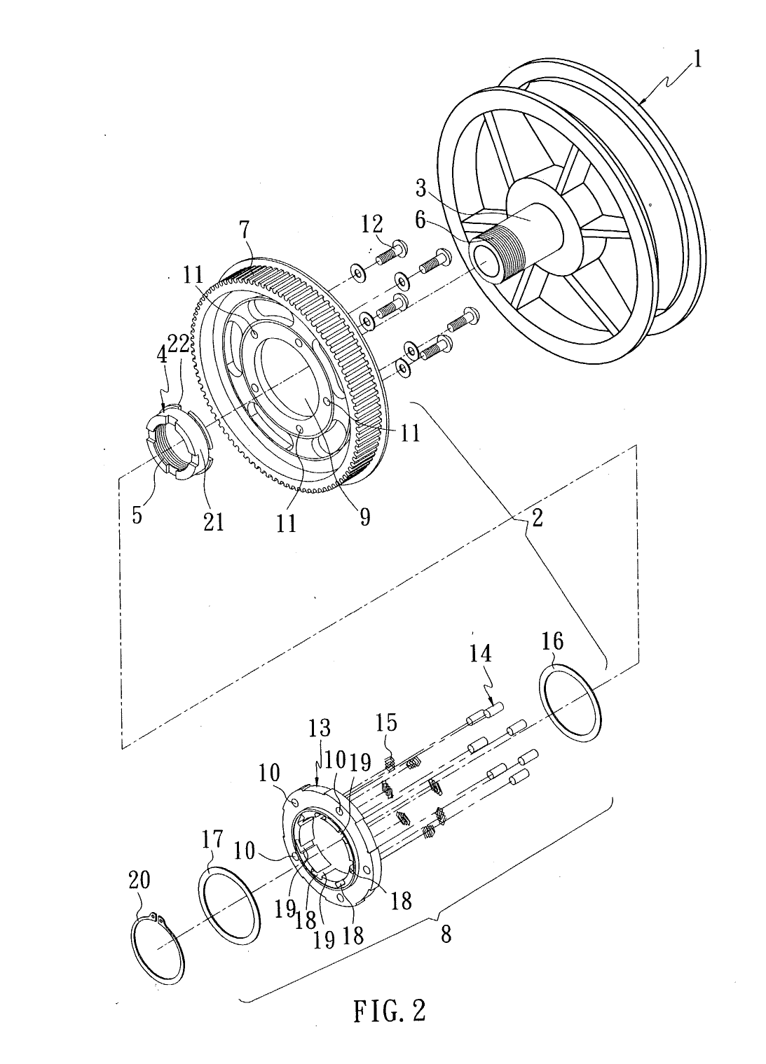

Referring to FIG. 1; FIG. 2 and FIG. 3, the wheel in this embodiment is omitted from tires and uses a wheel hub (1) to be the representation to show the structure between belt gear (2) and it. The axle sleeve (3) of a wheel hub (1) bulges out a wheel hub (1) in proper lengths. The exterior screw (6) is disposed on its outer edge for coupling the interior screw (5) of screw tube (4) in the center of the belt gear (2) in order to fasten the belt gear (2) in position. This belt gear (2) is combined with outer substance of gear (7) and the central self-acting clutch structure (8). Among them, the central hole of gear (7) has a connection structure to operate in the self-acting clutch structure (8) for coupling and fastening the self-acting clutch structure (8) in position. A connection structure is setting the central hole (9) operating in the self-acting clutch structure (8) to inlay into it partly in the center of gear (7); on gear (7) around the central hole (9), there is a fixed hole (11) on the edge of screw hole (10) which operates in the self-acting clutch structure (8) used for providing for the self-acting clutch structure (8) to make screw hole (10) and fixed hole (11) overlap locking by screws and washer (12) after the central hole (9) is inlaid partly. It means to fasten the self-acting clutch structure (8) in the center of gear (7).

As FIG. 1, FIG. 2 and FIG. 3 illustrate, the self-acting clutch structure (8) is composed of base ring (13), brake roller (14), compression spring (15), the first, second cover ring (16)(17) and screw tube (4). Among them, base ring (13) is a body of oblate ring and there are plural of slanting grooves (18) arranging in equal angles inside its wall to operate in containing brake roller (14) and compression spring (15), which are used for containing brake roller (14) in each point of opening inside the wall and also containing compression spring (15) in back groove (18) of brake roller (14); push each brake roller (14) toward groove (18) by the stretching force of each compression spring (15) to bulge slightly out the opening (19) inside the wall (19) and contact with the outer edge of screw tube (4). This brake roller (14) is a section of circular cylinder whose outer diameter operating in the width of groove (18) to individually contain compression spring (15) of each groove (18) and cover both sides of base ring (13) relative to each groove (18) by the first and second cover ring (16)(17); moreover, it pierces through screw tube (4) in the center of base ring (13) and closes slot (21) in one point of screw tube (4) by shackle (20) to seal brake roller (14) and compression spring (15) in the groove(8) which only bulges slightly out the opening (19) of the groove (18) inside the wall and contacts with the outer edge of screw tube (4) (as showing in FIG. 3). The compression spring (15) in the groove (18) is a rectangular compression spring to operate in width and outer diameter of brake roller (14) so its stretching force can have complete effects on brake roller (14). The first and second cover ring (16)(17) in point of the groove (18) covering both sides of base ring (13) are leaf rings having the same inner diameter to operate in the wall of base ring (13). Flange (22) is on its one point and slot (21) is on the other point, which pierces through the center of base ring (13) to fasten screw tube (4) in position by closing shackle (20) in slot (21)(as showing in FIG. 3).

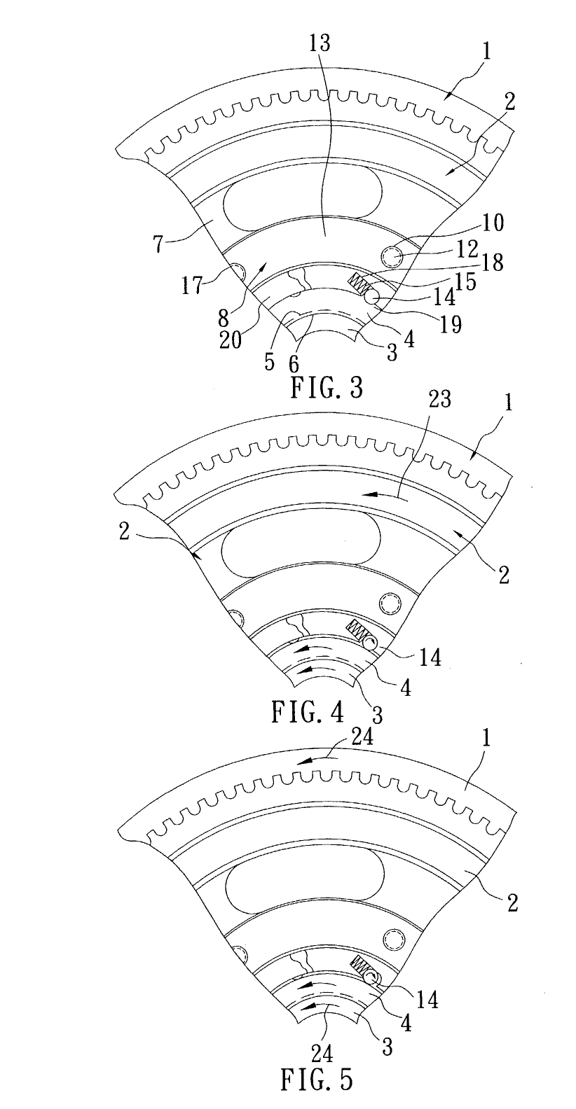

As showing in FIG. 4, the belt gear (2) in this embodiment is fastened in the center after screw tube (4) couples the axle sleeve (3) of a wheel hub (1). When the belt gear (2) rotates in the direction of arrow (23), it will drive each brake roller (14) rotating in the same direction to hold screw tube (4) for promoting a wheel hub (1) to rotate and drive cars progressing. When cars are progressed by pushing; as showing in FIG. 5, a wheel hub (1) and the axle sleeve (3) rotate in the direction of arrow (24) it will drive each brake roller rotating in the opposite direction to release screw tube (4) for achieving the effect of not anti-driving the belt gear (2).

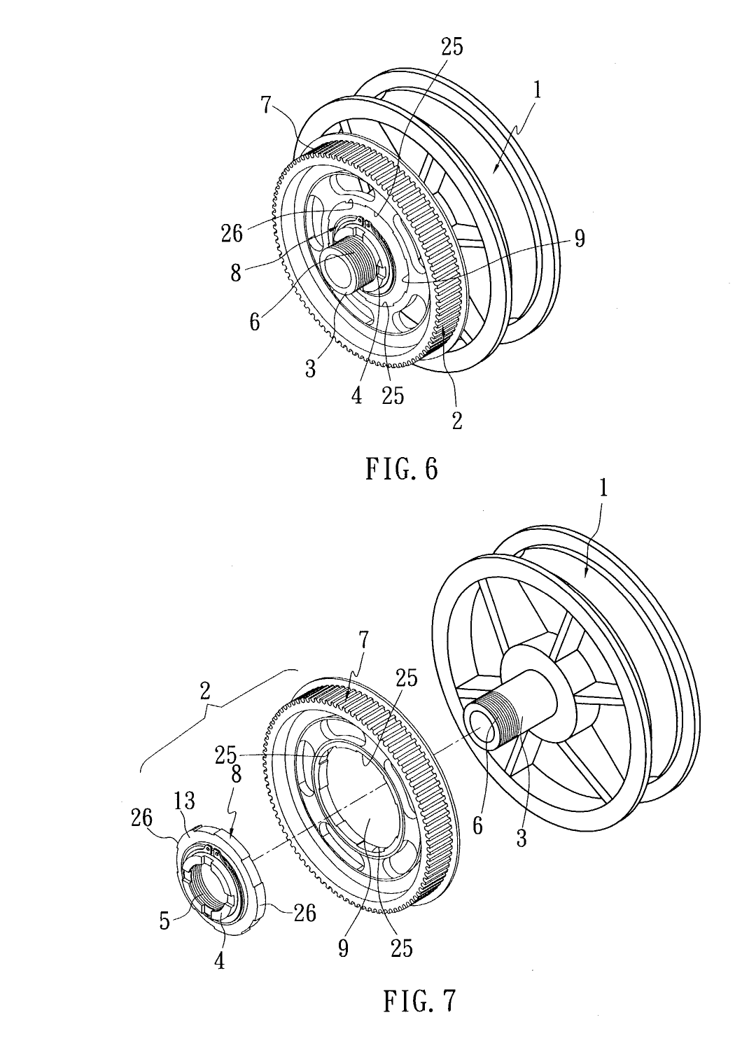

As showing in FIG. 6 and FIG. 7, the belt gear (2) fastened by coupling the axle sleeve (3) of a wheel hub (1) of the present invention, whose connection structure of the central hole (9) of gear (7) combined with the self-acting clutch structure (8) can also be with plural of inlaid grooves (25) arranging in the same distance and caving in the wall of the central hole (9) of gear (7) and on the outer edge of base ring (13) of the self-acting clutch structure (8) with plural of tenons (26) for facing each inlaid groove (25) of the central hole (9) of gear (7) by every tenon (26) so as to press pressure into the central hole (9) and fasten that can achieve the effect of identical connection. Other structures of this self-acting clutch (8) are completely the same with prior embodiment.

I claims:

1. An improved structure between wheel and belt gear, comprising:
wheel, whose central axle sleeve of a wheel hub of connection tire has the external screw bulging out a wheel hub for coupling the interior screw of screw tube in the center of the belt gear to be fastened in position;
belt gear, whose central hole of gear has a connection structure to operate in the self-acting clutch structure for coupling and fastening base ring and said self-acting clutch structure in position; said self-acting clutch, comprising:
base ring, which is a body of oblate ring and whose external is fastened in the central hole of said gear by connection structure; there are plural of slanting grooves to operate in brake roller and compression spring for containing brake roller and compression spring;
brake roller, which is a section of circular cylinder and whose outer diameter operating in the width of slanting groove of said base ring and contained individually in the opening of the groove bulging slightly out;
compression spring, which is a rectangular compression spring to operate in the length and outer diameter of said brake roller and contained in the back space of said brake roller of said groove so its stretching force is used for affecting said brake roller;
the first, second cover rings, which are leaf rings for covering both sides of slanting groove of said base ring to fasten both sides of said groove; and
screw tube, which is fastened by interior screw coupling said axle sleeve of a wheel hub; flange is on one point of its outer edge and slot on the other point, which pierces through said first cover ring, base ring and the second ring in turn to close slot by shackle.

2. An improved structure between wheel and belt gear of claim 1, within said the connection structure is to set fixed hole operating in screw hole of self-acting clutch structure on the edge of the central hole of gear and make fixed hole and screw hole overlap coupling the screw to be fastened in gear.

3. An improved structure between wheel and belt gear of claim 1, within said the connection structure also can be with plural of inlaid grooves caving in the wall of the central hole of gear and on the outer edge of base ring of self-acting clutch structure with tenon operating in facing inlaid grooves so as to press pressure into the central hole and fasten.
